(19) United States
(12) Patent Application Publication
(10) Pub. No.: US 2006/0153389 A1
(43) Pub. Date: Jul. 13, 2006

(54) Wireless audio signal transmission method for a three-dimensional sound system

(75) Inventors: Miodrag Temerinac, Gundelfingen (DE); Hans Fiesel, Gundelfingen (DE); Christian Bock, Freiburg (DE)

Correspondence Address: Patrick J. O'Shea;O'Shea, Getz & Kosakowski, Suite 912, 1500 Main Street,, Springfield, MA, 01115, US

(73) Assignee: Micronas GmbH, Freiburg (DE)

(21) Appl. No.: 10/519,590

(22) PCT Filed: Jun. 27, 2003
(86) PCT No.: PCT/EP03/06816

§ 371 Date: Sep. 12, 2005

(30) Foreign Application Priority Data
Jun. 28, 2002 (DE) 102 29 266.3

(51) Int. Cl. H04H 5/00

(52) U.S. Cl. 381/2

(57) ABSTRACT

A three-dimensional sound system includes a wireless audio signal transmission method for transmitting audio signals between a transmitting device and a spatially adjacent receiving device associated with an audio signal reproduction device such as a speaker. The audio signals may be digitized in the transmitting device, compressed, and transmitted by a digital high-frequency transmission method as data packets. Symbols may be assigned to the individual data in a quadrature signal plane. A diversity operation takes place between the transmitting device and the receiving device, where the transmitting device has two high-frequency transmitters with quadrature conversion which are each connected to an associated transmission antenna. On the receiver side, each audio signal reproduction device has a receiving device with one receiving antenna and one high-frequency receiver. Differentiation of the two received high-frequency data streams having the individual symbols in coded form may be implemented in a decoding device.

### PRIORITY INFORMATION

This application claims priority from International Patent Application No. PCT/EP03/06816 filed Jun. 27, 2003, and German Patent Application No. 102 29 266.3 filed Jun. 28, 2002.

### BACKGROUND OF THE INVENTION

The invention relates in general to audio reproduction systems and in particular to a wireless audio signal transmission method for a three-dimensional sound system.

In the home setting, modern audio reproduction systems are increasingly intended to provide multichannel sound reproduction based on the Dolby digital standard, the Digital Theater Standard (DTS), or some other three-dimensional sound method, in combination with a television receiver for digital reception or with a DVD player. With these systems, the audio signals are typically transmitted to up to six different speaker locations. In the home setting, however, the required installation of physical signal lines is often a problem. For this reason, there is often a desire to have wireless transmission that enables playback devices and speakers in different rooms to be interconnected.

Known wireless solutions are based on transmission links using frequency modulation. However, the quality of this type of analog transmission for speakers or headphones usually does not meet more demanding requirements. In addition, analog transmission is susceptible to interference, is not secure against being intercepted, and is inefficient in utilizing the available bandwidth. In the home setting, disturbed reception conditions are also to be expected due to reflections and shadowing.

An improvement is to replace the analog signal transmission by the transmission of data which have been generated by prior sampling and digitization of the analog signals. An example of wireless digital audio signal transmission is European patent application EP 0 082 905 A1. Using an infrared transmission device, digitized audio signals are transmitted by a transmitting device (e.g., a television receiver) to “active speaker boxes” within the room. The inconvenient physical signal lines are eliminated, while simple connections to the standard AC power supply provide power. Unfortunately, while this system is suitable for stereo signals, it is not applicable to multichannel sound system techniques.

What is needed is a multichannel sound system that avoids the above-described disadvantages without increasing the cost by an unreasonable amount.

### SUMMARY OF THE INVENTION

In a wireless audio signal transmission method for a three-dimensional sound system, the audio data for one or more audio signal transmitting devices are digitized, and the digitized data are transmitted as symbols by a digital modulation method. The number of required high-frequency channels is typically determined by the bandwidth specified for each channel together with the total bandwidth of the frequency range used. This method of transmission using symbols may employ a diversity method. Specifically, the interference caused by multipath reception and shadowing may be reduced through use of a diversity method. The propagation of HF and UHF signals within spaces is typically characterized by a plurality of mutually independent propagation paths from the transmitter to the receiver. In addition to a relatively strongly attenuated direct path, multiple indirect paths may arise depending on whether or not obstacles are present. Since the resulting path lengths typically differ, the individual audio signals generally arrive at the receiver at different phase positions. When the phase offset is 0°, 360°, or a multiple thereof, this is known as constructive interference. If, on the other hand, the phase offset is 180°, or 180° plus a multiple of 360°, this is known as destructive interference. If the two signals are equally strong, then the two signals cancel out each other. This effect is dependent on frequency since the phase shift over a fixed path length is a function of frequency. For example, field strength measurements between a transmitter and a receiver for which a movement occurred in an indoor space over a 15 meter path having reflections and obstacles demonstrated field strength drops of up to 30 dB at a frequency of 864 MHz, where the direct propagation path was attenuated by an obstacle.

In modern FM wireless speakers, this situation may be avoided through careful placement of the receiver. Since, however, people must also be taken into account as obstacles or reflectors, their movement results in a change in propagation conditions. This occurs, for example, if the receiver is portable, as with battery-powered headphones having a wireless connection to the transmitting device and a corresponding receiving device.

A simple solution may be to increase the transmission power. However, for legal reasons this is usually not possible with the available frequencies. Since the interference effects are a function of location and path, a solution may be to implement two or more mutually independent transmission paths using a diversity method. The frequency dependence of the interference phenomena can be exploited by transmitting on two different frequencies simultaneously, then selecting the better signal on the receiver side. However, this solution is not economical in terms of frequency. Another approach is receiver diversity. To maintain the independent paths needed for propagation, two receiving antennas are set up at a distance of at least a wavelength of λ/4 from each other. Either the relatively stronger antenna signal is selected by the receiver, or the two signals are combined. To avoid drop-outs during switching, this approach requires, however, that at least two receivers in complete form up to recovery of the channel-coded data be provided at each receiving site.

These and other objects, features and advantages of the present invention will become more apparent in light of the following detailed description of preferred embodiments thereof, as illustrated in the accompanying drawings.

### BRIEF DESCRIPTION OF THE DRAWINGS

FIG. 1 is a schematic diagram of a prior art transmitter and receiver diversity system having two separate channels;

FIG. 2 is a schematic diagram of a prior art transmitter diversity system with a single receiver;

FIG. 3 is a schematic diagram of a prior art receiver diversity system with a single transmitter;

FIG. 4 is a schematic diagram of a transmitter diversity system with separate transmitting channels and a single receiving channel;

FIG. 5 is a table illustrating the transmission of different data sequences within the system of FIG. 4;

FIG. 6 is a block diagram of a transmitter portion of the system of FIG. 4;

FIG. 7 is a block diagram of a receiver portion of the system of FIG. 4; and

FIG. 8 illustrates two different data formats that may be utilized by the receiver of FIG. 7.

### DETAILED DESCRIPTION OF THE INVENTION

An advantage provided by digitization of audio signals to be transmitted is a higher level of immunity against interference due to quantization which can then be further enhanced through the addition of check bits or other error-detection or error-correction methods. Another advantage is that known methods of compression for data reduction involve redundant properties of the audio signals to reduce the amount of data for transmission without any appreciable loss in quality.

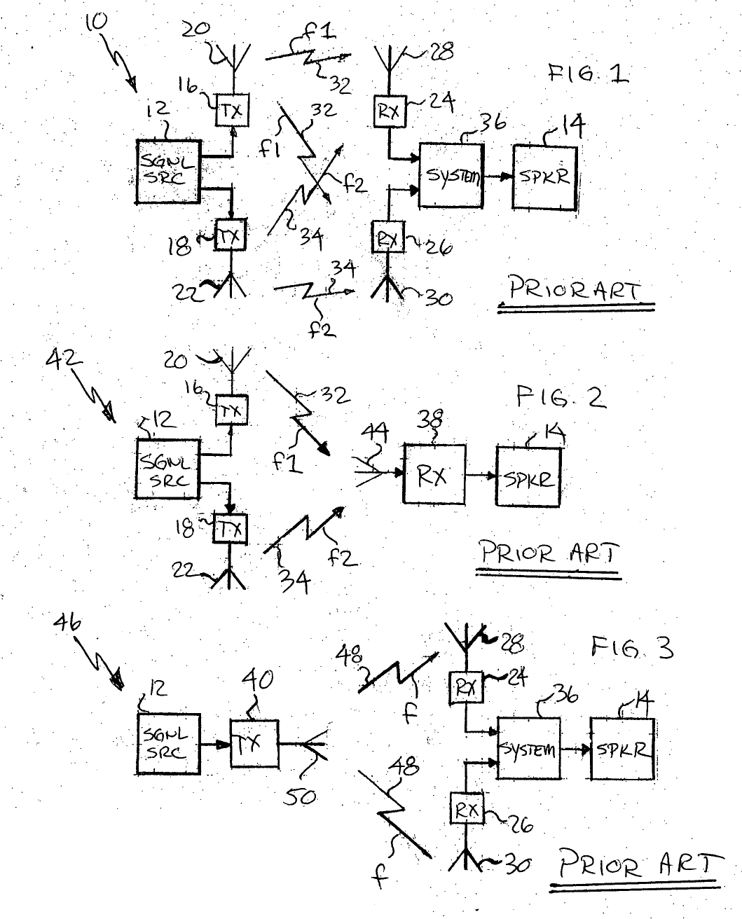

Unfortunately, the use of a diversity method increases the number of audio channels. For example, when using diversity methods, normally one transmitter and one receiver are required for each audio channel, as illustrated by the prior art diversity system 10 of FIG. 1. If each audio channel is designed in duplicate form, the resulting requirement for six speaker sites is twelve high-frequency (HF) audio channels, and an equal number of transmitters, receivers, and antennas. This approach is generally not cost-effective.

Referring to FIG. 1, a known diversity method implemented in a system 10 with two audio channels includes a signal source 12 connected to a reproduction device 14 (e.g., a speaker) through two transmitters 16, 18 with two antennas 20, 22, and two receivers 24, 26 with two antennas 28, 30. Two audio signals 32, 24 transmitted through the corresponding transmitting antennas 20, 22 have different transmission frequencies f1, f2. Evaluation of the received signals 32, 34 and generation of the actual audio signals therefrom for output through the speaker 14 may be implemented in an attached electronics system 36.

In the system 10 of FIG. 1, diversity is achieved based on the frequency-dependent propagation conditions for the two transmission frequencies f1, f2. This is because the phase positions due to reflections and obstacles vary, and generally given different frequencies an attenuation or even a cancellation may occur. The result is that one of the received signals 32, 34 typically has sufficient field strength. Additional improvements are possible by making the spacing between the transmitting antennas 20, 22 or the receiving antennas 28, 30 as large as possible, or by making the polarity and emission direction or reception direction different relative to each other. These measures can be carried out singly or in combination. A further improvement can be achieved not only by having the two receivers 24, 26 each detect one of the two different transmission frequencies f1, f2, but also by designing them to be as broadband as possible such that both frequencies f1, f2 are received. Separation of the frequencies and their contents may be carried out internally by filtering. The number of transmission paths is then doubled so that any undesired cancellations are less likely to occur.

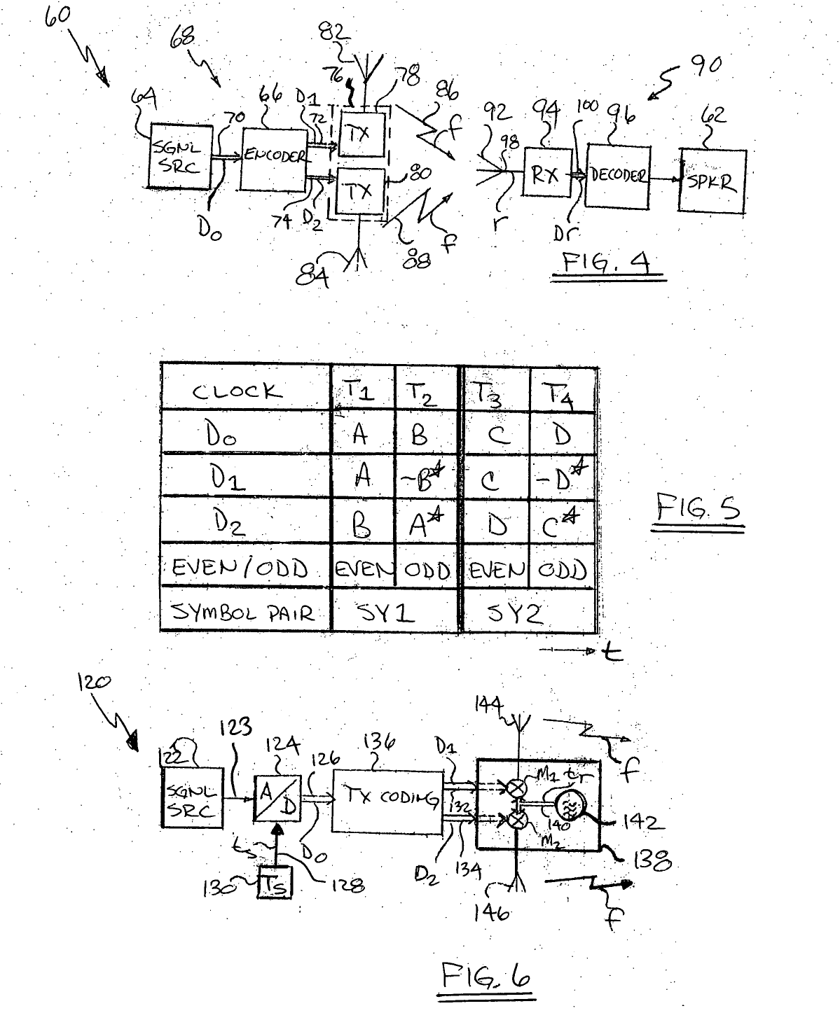

A more simplified approach may be provided by known, one-sided diversity methods which have separate transmission channels or receiving channels either on the transmitter side (FIG. 2), or on the receiver side (FIG. 3), opposite which channels is a single receiver 38 (FIG. 2) or a single transmitter 40 (FIG. 3). In the known transmitter diversity method illustrated in the system 42 of FIG. 2, the audio signals 32, 24 are transmitted by the two transmitters 16, 18 and the corresponding two antennas 20, 22, on two different frequencies f1, f2. On the receiver side, the two audio signals 32, 34 passing along different propagation paths are superimposed on each other and are detected by a single antenna 44 with the associated receiver 38. The transit time differences due to the frequency diversity and space diversity generally prevent any simultaneous total cancellation of the two frequencies f1, f2. In the receiver 38, either the signal content of the two frequencies f1, f2 is heterodyned, or that frequency is selected which at that instant has the higher field strength. An alternative system (not shown) of that illustrated in FIG. 2 employs the same transmitting antenna for both frequencies f1, f2. In this case, frequency diversity exists.

In the known receiver diversity method illustrated in the system 46 of FIG. 3, a single transmitter 40 transmits a signal 48 at the transmission frequency f through an antenna 50. On the receiver side, the signal 48 is received by the two separate antennas 28, 30 and the associated receivers 24, 26 to which, as in FIG. 1, the common electronics system 36 is attached which ultimately feeds the reproduction device 14. This method involves space diversity, although directional diversity or polarity diversity can be added through the receiving antennas 28, 30. The two signals from the receivers 24, 26 may either be heterodyned in the attached electronics system 36, or the system 36 may have a selection circuit which further processes the antenna signal with the higher field strength.

Receiver diversity may commonly be employed, for example, in professional settings for portable microphones since this type of situation ordinarily does not allow for multiple transmitting antennas. The frequency-modulated signal from the microphone transmitter is received by the associated receiver which is coupled to two extendable antennas, each of which is attached to a high-frequency receiver. While the diversity method may not be advantageous in this situation due to the relatively close spacing of the receiving antennas, the cost and complexity of the electronics involving sensitive receivers and the further relaying and processing of the signals are not of relatively high importance. If necessary, an additional receiver may be utilized.

For applications in the home setting, multiple antennas located in speakers may not be desirable for aesthetic reasons. Thus, the diversity methods in the systems 10, 46 of FIG. 1 and FIG. 3, respectively, are generally not utilized. However, a modified transmitter diversity method that is a refinement of the system 42 of FIG. 2 may be utilized, which is typically capable of transmitting data sequences. Any added expense in terms of equipment is essentially on the transmitter side and not the receiver side.

FIG. 4 illustrates a transmitter diversity system 60 with two separate transmitting channels and a single receiving channel. FIG. 5 is a table illustrating how the transmission of two different data sequences is implemented in the system 60 of FIG. 4 using the same transmission frequencies, as in the known space-time block code method. The principles of this method are described in detail for different variants, for example, in IEEE Signal Processing Magazine, May 2000, pages 76 to 91, in the article “Increasing Data Rate over Wireless Channels” by Ayman F. Naguib, Nambi Seshadri, and A. R. Calderbank. To use this method in the system 60 with high-end audio reproduction devices 62, a signal source 64 may supply data as audio signals, or, in the case of analog signals, digitization may occur in the source 64 or in an attached encoder 66.

On the transmitting side 68 of the system 60 of FIG. 4, a data stream Dₒ on a line 70 to be transmitted is processed within the encoder 66 and provided as first and second data streams D₁, D₂, on lines 72, 74, respectively, to a transmitter stage 76 having high-frequency transmitters 78, 80. The data streams D₁, D₂ are then transmitted through two spatially separated antennas 82, 84 as quadrature-modulated signals 86, 88, but in the same frequency band f despite different contents.

On the receiving side 90 of the system 60 of FIG. 4, a single antenna 92 along with a high-frequency receiving device 94 and a decoder 96 recover the original data sequence Dₒ from the heterodyned signals r on a line 98 from the antenna 92 or from a data sequence Dr on a line 100 from the receiving device 94 generated therefrom. The data sequence may be further processed and reproduced in the audio reproduction device 62.

Data compression on the transmitter side 68 may be utilized. High-frequency channels are relatively narrow-band and have a typical channel width of, for example, 300 kHz. By using data compression, it is possible to transmit data from two or more audio channels on one high-frequency channel. Data compression may exploit the redundancy in the audio signals, the right and left channel information of symmetrical speaker locations being suitable for this type of compression. The data stream may then be converted into symbols that are transmitted by the high-frequency carrier.

The digital transmission of symbols requires on the receiver side 90 an evaluation of the received signal at predefined times at which the transmitted signal occupies a defined state in the quadrature signal plane. To determine the state that corresponds to the transmitted symbol, the received signal is sampled and digitized, at least at defined times. The reduction of any interference, subsequent conversion, and decoding may also be implemented digitally. In zero-IF or low-IF receivers in which the two quadrature components are converted directly to the baseband or a low frequency position where they are digitized, receiving concepts can be provided that can be embodied within a single IC for each receiver, without significant external circuit elements. After frequency conversion, the decoding and subsequent signal processing may be implemented in a single digital signal processor. Thus, any inaccuracies in the analog component, such as phase errors or amplitude errors, can be corrected in the processor since asymmetries and inaccuracies as separate error sources are generally not possible.

In selecting a transmission band, a number of suitable high-frequency bands are available. The approved frequency range between 433.020 MHz and 434.790 MHz, also known as the “ISM band,” is less well suited since in this range there is no protection from other users or from the priority-status transmissions of amateur radio. Not only would an alarm system or a wirelessly-controlled central locking system of an automobile interfere, the FM signal can be intercepted. The 863 MHz to 865 MHz frequency band reserved for audio transmission has found only reluctant acceptance, likely because the 10 mW approved radiated power (ERP) is relatively low for operation not subject to individual certification. Within close range, the use of this frequency band for the wireless control of audio reproduction devices may be suitable if the transmitting and receiving antennas are within sight of each other. Otherwise degradations in reception may result. As mentioned hereinabove, the transmitted audio signal is not only subject to attenuation but also to multiple reflections. Whenever two of these signal components arrive at the receiver in phase opposition but with approximately the same intensity, they cancel each other completely. In the extreme case, an almost complete loss of reception may result.

A frequency band around 40 MHz is not suitable due to the narrow bandwidth. Strong interference may occur in the segment around 432 MHz in the 70-cm amateur band. Frequencies in the GHz range are not suitable based on the higher component costs and increasingly unfavorable propagation conditions. In addition, the lowest portion of this range around 2450 MHz is already utilized by a number of services and users such as Bluetooth, wireless data links, and microwave ovens. What remains is thus the range around 864 MHz. This range is specifically intended for wireless audio applications in streaming mode (duty cycle=1), that is, the high-frequency carrier in each channel can be in action continuously. Due to the limited bandwidth of only 2 MHz for this entire frequency band, the audio data have to be compressed. To provide simultaneous video reproduction, lip-synchronicity is required, with the result that allowable delay between video and sound is approximately 20 ms This delay is relevant in light of the chosen compression method along with the desire for highest possible fidelity of reproduction. Compression methods that computationally compress the 16-bit or 24-bit audio data to six bits per sampling value are known. For example, see the adaptive differential pulse code modulation (ADPCM) method or other methods in K. D. Kammeyer, “Information Transmission”, B. G. Teubner Stuttgart, 2^{nd} edition 1996, pages 124 through 137, Chapter 4.3 entitled “Differential Pulse Code Modulation.” A stereo signal sampled at 48 kHz yields a data rate of 576 kB/s. Higher-level compression methods such as MP3 that enable a stronger compression are not suitable since their delay is too large. Also, a transmitter-side preliminary delay of the video information in the home setting is too complex.

The 16-QAM method may be selected as the digital modulation approach to transmit the symbols. This method represents a compromise between transmission capacity and implementability. Extensive system analyses show that a ¾ trellis coding of the modulation provides for sufficient error protection. The gross data rate for the stereo signal is approximately 768 kB/s. Synchronization and control of the spatially distributed audio reproduction devices require a small number of additional data to be transmitted such that the final data rate is approximately 840 kB/s. The resulting symbol rate of 210 kS/s can be accommodated with a roll-off factor of 19% within a 250-kHz-wide channel. As a result, eight HF carriers, each with two audio channels, are available within the 2-MHz-wide segment between 863 MHz and 865 MHz.

A fully expanded system having six-channel sound typically requires three of the eight HF channels, with the result that two of these systems can be operated in parallel within a house without interfering with each other. However, often the center and sub-loudspeaker are connected directly by wire to the playback device, with the result that only two HF channels are needed. In addition, the system provides for dynamic assignment of the channels, with the result that a single carrier is used for one stereo signal, even when more than two speakers are operated. The fundamental consideration is that two antennas be set up sufficiently separated from each other on at least one side of the transmission path, with a single antenna on the opposite side, to form two mutually independent transmission links. This fundamental consideration is also valid in the case in which the two antennas are located on the transmitter side. Where a backward channel is lacking, the transmitter typically cannot choose between the two antennas since it does not have any information about the respective reception conditions. As a result, the useful signal is transmitted twice to obtain the diversity gain, without simultaneously causing a mutual degradation of the two signals. A solution is the above-mentioned space time coding method, whose space-time block codes (STBC) or space time trellis codes (STTC) meet this requirement.

The table of FIG. 5 illustrates the STBC method of coding and transmitting a data sequence Dₒ on the line 70 (FIG. 4) with data A, B, C, D. The first line labeled “clock” indicates the successive clock times T₁, T₂, T₃, T₄ for the original data sequence Dₒ and transmission of the symbols. The original data sequence Dₒ with data A, B, C, D is in the second, line. The third and fourth lines indicate a first data sequence for the data D₁ on the line 72 obtained by conversion with the data A, −B*, C, −D*, and a second data sequence for the data D₂ on the line 74 with the data B, A*, D, C*. The third and fourth lines represent the symbol sequences that are transmitted using quadrature signals by the two antennas 82, 84. The asterisk * illustrated as part of various data values indicates the complex conjugate of that particular data value. The fifth line indicates the even and odd times for the times T₁ through T₄. The sixth line indicates the combination of symbols A, B, and C, D to form a first or second symbol pair Sy1, Sy2. The data sequences D₁, D₂ may also be combined differently, for example, D₁ with A, B*, C, D*, and D₂ with −B, A*, −D, A*, or in other combinations. It suffices that symbols A, B, C, D are coded differently in the two data sequences and that the appropriate equations are available on the receiving side.

In a first step during time T₁, the two successive symbols A, B are transmitted in parallel. The antenna 82 transmits the symbol A and the antenna 84 transmits the symbol B. For purposes of differentiation, the two successive symbols A, B are identified as a symbol pair, the first symbol A being identified as the even symbol, and second symbol B being identified as the odd symbol. Subsequently, transposition and transformation of the two initially transmitted symbols A, B takes place, with the result that in the second step during time T₂ at the antenna 82 the symbol B is transmitted in the form of the negated complex conjugate as −B*, while the symbol A is transmitted in the form of the complex conjugate as A*. After two steps T₁, T₂, a symbol pair A, B, (i.e., the first symbol pair Sy1) is thus transmitted. During the third and fourth times T₃, T₄, the second symbol pair Sy2 with symbols C, D is transmitted in an identical manner. Each symbol is thus transmitted twice. Since, however, there is also a parallel transmission through both of the transmitting antennas 82, 84, the data rate for the data sequence Dr on the line 100 on the receiver side 90 is identical to the original data rate of the data sequence Dᵣ on the line 70 (FIG. 4).

On the receiver side 90, the symbols A, B, or C, D received at the same frequency and superimposed are separated. Mathematically, this corresponds to the solution of a linear equation system with two unknowns A and B:
rₑᵥₑₙ=h1·A+h2*B (Eq. 1)
r_{odd}=h2·A*+h1·(−B*) (Eq. 2)
r_{odd}*=h2·A−h1*·B (Eq. 3)
Equation 2 is generated by transformation of Equation 1. Here h1 denotes the transfer function from the first transmitting antenna 82 to the receiving antenna 92, while h2 denotes the transfer function from the second transmitting antenna 84 to the receiving antenna 92. The received signal value rₑᵥₑₙ at time “even” is comprised of components A and B, and the two transfer functions h1 and h2. The received signal value r_{odd} at time “odd” is comprised of the components h1, h2, A* and −B*. As long as transfer functions h1 and h2 are known, Equations 1 and 2 represent a linear system from which A and B can be determined. If the complex conjugate form corresponding to Equation 3 is generated from both sides of Equation 2, then the symbols A, B are identical with the symbols of Equation 1.

The transfer functions h1, h2 are initially unknown. However, they generally represent a steady state since the spatial conditions relative to the data rate change relatively slowly. In addition, if it can be assumed that both transfer functions are initially equal, they then seek a more desirable value by a control action on the receiver side 90. To this end, the received signals on the receiver side 90 are multiplied by an inverse transfer function in a linear combination device 108 (see FIG. 7) which is initially present as an estimated value. The received signals are then adapted by an adaptive algorithm to the actual transfer functions of the two transmitting antennas 82, 84. Referring also to FIG. 7, the transfer functions h1 and h2, along with their associated inverse transfer functions h₁⁻¹ and h₂⁻¹ in the linear combination device 108 together form a linear frequency response. Based on the linear combination device 108, the symbols A′, B′ received after the transfer are translated into the quadrature signal plane such that a symbol decision element 110 can determine the associated decided symbols A″, B″ from these values. If, as a result of transfer changes in the received symbols A′, B′, deviations occur relative to the inverse transfer functions h₁⁻¹, h₂⁻¹ in the linear combination device 108, these deviations are detected essentially as differences by an equation system in an arithmetic unit 112. These difference values are then smoothed by a control loop filter 114 and supplied as correction values to the linear combination device 108.

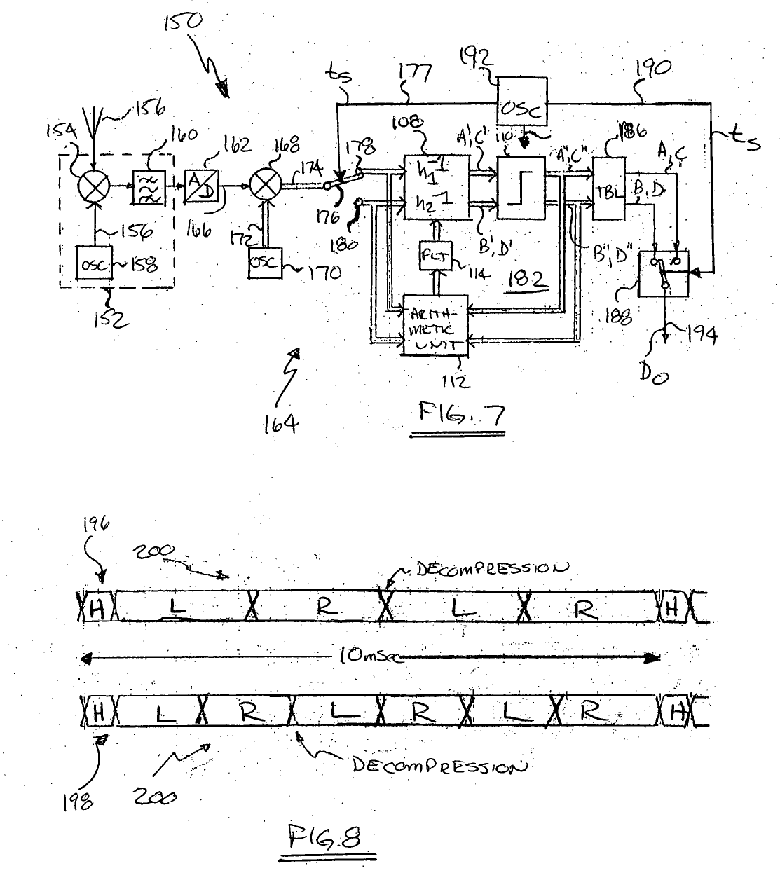

Referring to FIG. 6, a transmitting device 120 includes a signal source 122 that supplies an analog audio signal on a line 123 to an analog-to-digital converter (ADC) 124. The output of the ADC 124 is a data stream Dₒ on a line 126 with a symbol rate determined by a digitization clock tₛ provided to the ADC 124 on a line 128. The digitization clock on the line 128 corresponds to the symbol clock tₛ generated in a symbol clock generator T, 130, or a multiple thereof. Two different data streams D₁ and D₂ on the lines 132, 134 are generated from the data stream Dₒ on the line 126 in a transmission coding device 136. The data streams D₁, D₂ contain the individual symbol pairs A, B, and C, D, with the respective different coding in the quadrature signal plane as illustrated in FIG. 5. In a high-frequency stage 138, the two data sequences D₁, D₂ on the lines 132, 134 are transferred to a desired high-frequency band by the sine and cosine components of a quadrature carrier signal tr on a line 140 from a high-frequency oscillator 142, then transmitted separately through antennas 144, 146. For clarity, the required pulse form filter, as well as the filter devices to avoid interference and alias signals, are not illustrated in FIG. 6 but are readily apparent to one of ordinary skill in the art.

Referring to FIG. 7, a receiving device 150 includes a heterodyne receiver 152 that includes a high-frequency mixer 154 that converts the high-frequency signal received through antenna 156 from the high-frequency channel f to an intermediate frequency position which lies approximately in a frequency range of 1 to 2 MHz. The carrier for the mixer 154 is a high-frequency signal HF on a line 156 from a local oscillator 158. A bandpass filter 160 filters out the desired frequency band and provides a filtered signal to an analog-to-digital converter (ADC) 162 for digitization. The conversion to an intermediate frequency uses the ADC 162. In the case of zero-IF conversion or low-IF conversion, there is a splitting into two channels that are in quadrature with each other and also require two analog-to-digital converters. Subsequent processing in a decoding device portion 164 may be implemented digitally and independently of the preceding heterodyne receiver stage 152.

The digitized signal on a line 166 from the ADC 162 is converted by a quadrature mixer 168 and decimation stages (not shown) such that the data rate of the resulting data stream corresponds to the symbol rate tₛ or an integral multiple thereof. The quadrature mixer 168 is fed by an oscillator 170 with a signal on a line 172 that comprises sine and cosine components of the down-mixed carrier frequency which also produce two mixing components at the output of the mixer 168 on a line 174. If the heterodyne receiver circuit 152 is a zero-IF converter or low-IF converter, then two in-quadrature data paths in the low-frequency position are present and the quadrature mixer 168 may be omitted.

The two mixing components on the line 174 comprise digitized signal values which may be coupled to the transferred symbols. A switch 176 distributes these values synchronously at symbol clock tₛ on a line 177 to two outputs 178, 180 of the switch 176, thereby supplying inputs of a symbol detection device 182.

The signals on the line 174 from the mixer 168 are alternately divided by the switch 176 between the two inputs of the symbol detection device 182, at the output of which the determined symbols can be tapped from the received signal. Based on the alternating division and subsequent solution of the linear equations for the received signals in the linear combination device 108, the preliminary estimated symbols A′, B′, or C′, D′ of each symbol pair Sy1, Sy2 are available at the outputs of the device 108. The decision element 110 generates the decoded symbols A″, B″, or C″, D″ therefrom which are converted by a table 186 into electronic data for symbols A, B, C, D for further processing. From the parallel available symbols A, B, or C, D of the symbol pairs, a switch 188 alternately controlled at a symbol clock tₛ on a line 190 from a clock generator 192 regenerates the original data sequence Dₒ on a line 194 with data A, B, C, D. This data stream can then be converted into the audio signal for output through the speaker.

During decoding of the symbols, specifically, in the zero-IF or low-IF methods, a situation may occur in which the carrier is placed in an active frequency band during mixing. As a result, a large steady-state component is generated in the down-mixed signal. This component may generally exceed the operational ranges of the analog-to-digital converters. In the process of down-regulating the signal value, resolution may be lost. As a result, a simple control loop may be used to superimpose a sufficiently large direct component on the analog signal before digitization until the signal is within the control range of the analog-to-digital converters.

The adaptation of the parameters in the linear combination device 108 (FIG. 7) is implemented by sending the signals of the two inputs 178, 180, and the two outputs A″, C″ and B″, D″ of the symbol decision element 182 to one input each of the arithmetic unit 112 for comparison. In the steady-state condition, the received symbols A′, B′, C′, D′, and the decided symbols A″, B″, C″, D″ are linked by the inverse transfer functions h₁⁻¹, h₂⁻² in the linear combination device 108. This is done up to the point of unavoidable noise components, since the inverse transfer functions compensate the transmission paths. Deviations in linearity may be determined by the equation systems in the arithmetic unit 112 which generate correction signals that are supplied by the control loop filter 114 to correction inputs of the linear combination device 108.

For the purpose of conversion to the audio signal, however, additional information is typically required, such as the volume, tone, or balance which are a function of the specific location of the audio reproduction device. The additional control information relates to the location of the device within the three-dimensional sound system. That is, the address of the device, the data compression method used, information on the applicable protection measures to secure data during transmission, and synchronization bits to detect the data package beginning and to synchronize symbol detection. This control information may be inaudibly superimposed on the actual audio signal, or transmitted in addition to this signal. For transmission, a packet format that contains all the requisite control information and addresses in a header may be utilized. The actual data component then contains the data for the audio signal, and also the check bits or empty bits to fill out the individual data ranges.

Since the source data streams may be already digitized, a sampling rate conversion or even recoding with a detour via an analog signal is typically avoided. This however requires the transmission of different sampling rates such as 44.1 kHz or around 48 kHz, and integral multiples thereof. The selected data packet structure (a frame) may be 10 ms long. Following a header with synchronization bits and control parameters, two stereo blocks with 2×240 6-bit values each are transmitted at 48 kHz. At 44.1 kHz, three stereo blocks with 2×147 6-bit values each are transmitted. At 44.1 kHz and lower sampling rates, the extraneous bits in the individual data blocks are filled with a predefined bit sequence.

Referring to FIG. 8, there illustrated are data formats 196, 198 for transmission of the audio data in the receiver 150 of FIG. 7. Both data formats represent one data packet 200 each of 10 ms length. The upper data format 196 is suitable for a source rate of 48 kHz, while the lower format 198 is suitable for a source rate of 44.1 kHz. The individual data blocks for the left and right audio channel L or R alternately follow the header H. A compression may be oriented by pairs to these blocks such that the decompression can begin on the receiver side each time after reception of the first audio block pair L, R. In the upper format 196, this corresponds to a delay of about 5 ms, while it is 3.3 ms for the lower format 198. On the transmitter side, approximately the same delay value is added, with the result that the specification of lip synchronicity which requires a delay of less than 20 ms between video and sound can be met.

Although the present invention has been illustrated and described with respect to several preferred embodiments thereof, various changes, omissions and additions to the form and detail thereof, may be made therein, without departing from the spirit and scope of the invention.

What is claimed is:

1. A method for wireless transmission of audio signals between a transmitting device and a receiving device, the receiving device having an audio signal reproduction device, the method comprising the steps of:
digitizing the audio signals;
coding the digitized audio signals;
transmitting the coded digitized audio signals as separate data streams
receiving the transmitted data streams;
decoding the received data streams;
outputting the decoded data streams through the audio signal reproduction device; and
providing transmitter diversity between the transmitting device and the receiving device where the transmitting device includes two transmitters each having an associated antenna and operating in the same frequency band, the receiving device having at least one receiving antenna and at least one receiver for the frequency band.

2. The method of claim 1, where the step of digitizing further comprises the step of digitizing the audio signals into a data sequence, and where the method further comprises the steps of:
converting the data sequence into a first and second data sequence of successive symbol pairs, wherein in the first and second data sequence the symbol pairs that are related in time include the same symbols;
transposing the order of the symbols within the symbol pairs in the first and second data sequence relative to each other in a time sequence; and
implementing a change in coding of quadrature signal components representing the coded digitized audio signals, wherein the change in coding relates to a sign of the symbol.

3. The method of claim 2, where the change in coding relates to a transformation of the symbol to its complex conjugate value.

4. The method of claim 1, where each digitized audio signal has a plurality of discrete data points, and where the step of coding further comprises the step of assigning a symbol in a quadrature signal plane to each discrete data point.

5. The method of claim 1, further comprising the step of compressing the digitized audio signals prior to the step of transmitting and further comprising the step of decompressing the digitized audio signals after the step of receiving.

6. The method of claim 1, where the separate data streams are transmitted as data packets, each packet including header information comprising control and auxiliary information, each packet including data corresponding to the audio signals where each packet includes an even number of data blocks by which data associated with a first and second audio channel are alternately transmitted in blocks.

7. A system for wireless transmission of digitized audio signals, comprising:
a transmitting device; and
a receiving device;
where the transmitting device includes a coding device that codes the digitized audio signals as data packets; and includes
two transmitters that generate quadrature signals in the same frequency band which are modulated with the data packets and are transmitted by a corresponding antenna for each transmitter, where
the antennas are located in a spatial relationship for transmitter diversity operation; and
where the receiving device includes an audio reproduction device and at least one receiver that receives the transmitted quadrature signals, the receiving device further includes a decoder that decodes the received quadrature signals and provides a decoded audio signal to an audio reproduction device.

8. The system of claim 7, where the digitized audio signals are arranged in a first data sequence, the coding device generates a pair of data sequences from the first data sequence, and where the transmitting device include quadrature mixers that convert the pair of data sequences to the same high-frequency band and provide the converted data sequences to the corresponding antennas for transmission.

9. The system of claim 8, where the coding device generates the pair of data sequences based on a space-time block code.

10. The system of claim 8, where the pair of data sequences each includes data that represents symbols arranged as successive symbol pairs that are related in time.

11. The system of claim 9, where the decoding device decodes the data sequences based on the space-time block code, and where the receiving device includes first switch that supplies the received quadrature signals to a first and second terminal of a linear combination device at a clock period of a symbol rate, a symbol decision element connected to two outputs of the linear combination device a symbol table connected to the symbol decision element that supplies a logical level of each of the associated symbols within the received quadrature signals, and a second switch that regenerates the first data sequence from the symbols by alternate switching at the symbol clock period.

12. A system for wireless transmission and reception of audio signals, comprising a transmitter side and a receiver side, where the transmitter side comprises:
a source of audio signals that provides the audio signals in a data sequence;
an encoder that codes the data sequence into a pair of data streams;
a pair of transmitters that each transmits a corresponding one of the pair of data streams; and
a pair of transmitting antennas each associated with a corresponding one of the pair of transmitters, the transmitting antennas being located in a spatially-separated transmitter diversity relationship with each other, the antennas transmitting the corresponding one of the pair of data streams on a frequency that is that same for each antenna;
and where the receiver side comprises
a receiving antenna that receives the transmitted pair of data streams;
a receiver that processes the received data streams;
a decoder that recovers the data sequence from the processed data streams and provides an audio signal in response thereto; and
an audio reproduction device that outputs the audio signal from the decoder.

13. The system of claim 12, where the audio signals are in analog format, and where the transmitter side digitizes the audio signals.

14. The system of claim 12, where the audio signals are in digital format.

15. Ths system of claim 12, where the transmitter side compresses the data sequence, and where the receiver side decompresses the data sequence.

16. The system of claim 12, where the encoder codes the data sequence into a pair of data streams each comprising symbols.

17. The system of claim 16, where the transmitters transmit the data streams comprising symbols using quadrature amplitude modulation, and where the receiver processes the received data streams by evaluating the received data streams at predefined times at which each of the symbols within the transmitted data streams occupies a defined state in the quadrature signal plane.

18. The system of claim 17, where the receiver determines the defined state that corresponds to the transmitted symbols by sampling and digitizing the received data streams at least at defined times and at a frequency that is lower than the frequency that the data streams are transmitted.

19. The system of claim 16, where the encoder codes the data sequence using space-time block codes, and where the receiver processes the received data streams using space-time block codes.

20. The system of claim 12, where the transmitters modulate the pair of data sequences onto a high-frequency carrier signal, and where the receiver converts the received data streams to a frequency that is lower that that of the high-frequency carrier signal.
